(19) United States
(12) Patent Application Publication
(10) Pub. No.: US 2015/0106703 A1
(43) Pub. Date: Apr. 16, 2015

(54) ADAPTIVE GRAMMAR INSTRUCTION FOR PREPOSITIONS

(71) Applicant: Apollo Education Group, Inc., Phoenix, AZ (US)

(72) Inventors: Scott Fraundorf, Rochester, NY (US); Michael Wasson, Pittsburgh, PA (US); Alison Huettner, Pittsburgh, PA (US); Ryan Schwiebert, Pittsburgh, PA (US)

(21) Appl. No.: 14/326,313

(22) Filed: Jul. 8, 2014

Related U.S. Application Data
(60) Provisional application No. 61/890,875, filed on Oct. 15, 2013.

(51) Int. Cl. G06F 17/24; G09B 7/00; G06F 3/0484; G06F 17/27; G06F 17/28

(52) U.S. Cl. CPC G06F 17/24; G06F 17/274; G06F 17/28; G06F 3/0484; G09B 7/00
USPC 715/271

(57) ABSTRACT

Techniques are described for an automated grammar teaching system that displays sentences and allows a user to identify preposition errors within the sentences, if any. The sentences may be presented as single sentences or as part of a paragraph. The user may be asked to determine whether the sentences are correct or incorrect, to identify the locations of missing or incorrect prepositions, to provide a new correct preposition, and to identify a correct preposition usage category for the new preposition. To guide the user, an incorrect user response may trigger the display of remediation information, which may include identifying one or more grammar elements of the sentences that are relevant to identifying the preposition errors. New sentences in the teaching system may be selected based on historical data maintained for the user.

### CROSS-REFERENCE TO RELATED APPLICATIONS; BENEFIT CLAIM

This application claims the benefit of U.S. Provisional Application No. 61/890,875, filed Oct. 15, 2013, which is hereby incorporated by reference in its entirety for all purposes as if fully set forth herein.

### FIELD OF THE INVENTION

The present invention relates to teaching better mastery of prepositions in written language, and, more specifically, to an adaptive grammar teaching system configured to train users on identifying and correcting preposition errors in formal written English.

### BACKGROUND

Preposition choice is largely arbitrary in English, with few generalizations or regularities that can be taught. In most cases, a given noun, verb, or adjective selects its own idiosyncratic prepositions. Even for prepositions less tightly bound to a content word, there are few hard-and-fast rules. Writers who are less familiar with the formal register used in academic writing often choose the wrong preposition to use with unfamiliar constructions or vocabulary. Issues with preposition choice make it hard to write an error-free research paper or formal letter, which limits that person's ability to communicate effectively through writing. Remediation is difficult, since correct usage is largely a matter of memorization, not rule mastery.

Grammar checkers, e.g., Grammerly.com, Thelma Thistleblossom, and grammar checkers included with document editors such as Microsoft Word, identify certain types of grammatical errors in written documents. However, grammar error identification/correction is not the same as teaching either rules or specific content word/preposition pairs, even when the grammar checker indicates the correct preposition. Thus, grammar checkers generally do not give any guidance on how to choose the correct preposition, nor do grammar checkers target particular problems that users have with prepositions. At times, the grammar checkers identify “errors” that are not grammatical errors at all, and rely on the knowledge of the user to ultimately determine whether an error exists. Thus, grammar checkers are generally ineffective at helping a user improve his or her preposition usage.

Some English courses, e.g., in secondary and higher education, may attempt remediation for poor preposition selection. In most cases, this involves correcting errors after they have been made, though face-to-face teaching techniques, quizzes, and other activities may also be used. At times, automation is used in such traditional English courses. However, this automation generally consists of providing a student with multiple-choice questions and giving the student feedback on the student's selected answers. It can be difficult for an English teacher to identify and aid each student with the students' individual preposition problems, especially since classes tend to be large and students tend to have a wide range of skill gaps with respect to mastery of preposition selection in formal language. The above mentioned deficiencies can allow students to complete English courses without learning any of the preposition conventions that they need to produce error-free communications.

Therefore, it would be beneficial to provide an automated grammar teaching system that is configured to help students master and exploit what local regularities do exist in preposition selection. These local regularities may include: any groups of semantically related words that select the same prepositions, especially when students tend to make a consistent preposition mistake with such words; any instances where there is a semantic generalization to be made regarding a particular usage of a particular preposition; any grammatical construction in which formal and informal preposition usage contrast sharply; any other clearly contrasting usage between two particular prepositions; any prescriptive rules that students are expected to observe; any specific substitution error that a population of students consistently makes; etc.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example network arrangement for an automated grammar teaching system that adaptively instructs a user regarding regularities in preposition usage in sentences.

FIG. 2 depicts a flowchart for receiving input information from a user identifying preposition errors in a displayed natural language sentence.

FIG. 3 depicts a graphical user interface configured to allow a user to identify, within a displayed sentence, preposition errors.

FIG. 4 depicts a flowchart for receiving input information from a user identifying a correction of a preposition error in a displayed natural language sentence and determining whether the correction is accurate.

FIG. 5 depicts a graphical user interface configured to allow a user to identify a correction of a preposition error within a displayed sentence and to display remediation information about an inaccurate correction, by a user, of a preposition error.

FIG. 6 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

An automated grammar teaching system delivers highly personalized, differentiated instruction to users. The automated grammar teaching system provides lessons and adaptive practice to build each student's skills for selecting prepositions. Preposition problems are automatically presented to students by the automated grammar teaching system, and are constructed to address each student's continuous learning needs with respect to granular skills relating to prepositions.

According to one embodiment, preposition problems are presented, using a user interface, to a user. The problems may be presented as 1) single sentences, 2) contrasting sentence pairs that are designed to emphasize correct preposition selection in different sentence contexts and scenarios, or 3) a paragraph having multiple sentences. The user may be asked to 1) identify whether each sentence is correct with respect to preposition usage, 2) locate, if necessary, the preposition to correct or the position to insert a new preposition, 3) identify the category that the preposition usage falls under, and/or 4) make the correction by typing the correct preposition, if necessary. In some embodiments, the identification of the category is omitted or made optional.

In an embodiment, if a user incorrectly identifies a particular portion or an entirety of a sentence as having a preposition error, then the system displays remediation information to help the user understand why the identification is incorrect. In an embodiment, if a user provides an inaccurate correction to a preposition error, the system displays remediation information to explain why the correction that the user specified is inaccurate. Further, the automated grammar teaching system records, as historical data, a user's actions within the system. The system uses this historical data to identify what sentences, with what kinds of preposition errors, the system should provide to the user.

### Adaptive Grammar Instructions Architecture

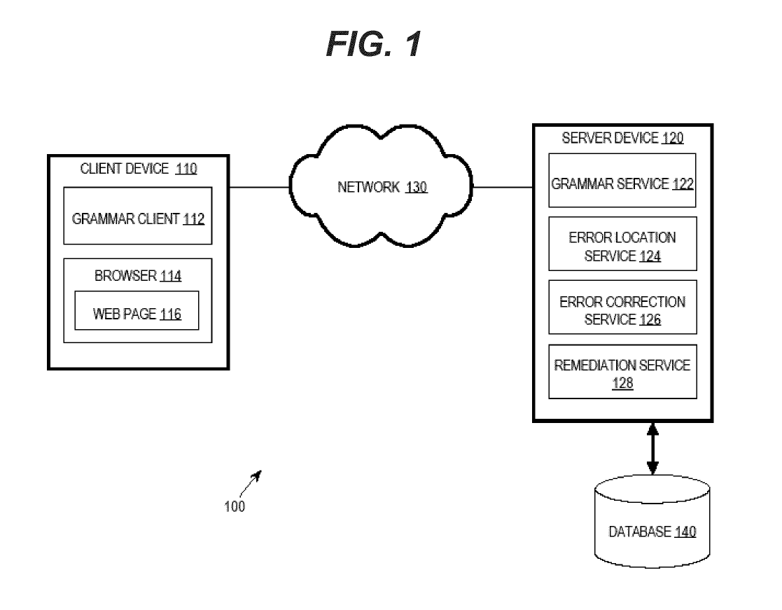

Techniques are described hereafter for adaptively instructing a user on grammar rules governing preposition usage in sentences. FIG. 1 is a block diagram that depicts an example network arrangement 100 for an automated grammar teaching system that adaptively instructs a user regarding regularities in preposition usage in sentences, according to embodiments. Network arrangement 100 includes a client device 110 and a server device 120 communicatively coupled via a network 130. Server device 120 is also communicatively coupled to a database 140. Example network arrangement 100 may include other devices, including client devices, server devices, and display devices, according to embodiments. For example, one or more of the services attributed to server device 120 herein may run on other server devices that are communicatively coupled to network 130.

With respect to FIG. 1, server device 120 may correspond to server device 120 from FIG. 1.1 of the parent provisional application, as described in Section 1.0 of the parent provisional application. Accordingly, additional services such as mastery tracking service 124 and hint service 126 from service device 120 in FIG. 1.1 of the parent provisional application may also be included in server device 120 of FIG. 1.

Client device 110 may be implemented by any type of computing device that is communicatively connected to network 130. Example implementations of client device 110 include, without limitation, workstations, personal computers, laptop computers, personal digital assistants (PDAs), tablet computers, cellular telephony devices such as smart phones, and any other type of computing device.

In network arrangement 100, client device 110 is configured with a grammar client 112 and a browser 114 that displays web page 116. Grammar client 112 may be implemented in any number of ways, including as a plug-in to browser 114, as an application running in connection with web page 116, as a stand-alone application running on client device 110, etc. Grammar client 112 may be implemented by one or more logical modules, and is described in further detail below. Browser 114 is configured to interpret and display web pages that are received over network 130 (e.g., web page 116), such as Hyper Text Markup Language (HTML) pages, and eXtensible Markup Language (XML) pages, etc. Client device 110 may be configured with other mechanisms, processes and functionalities, depending upon a particular implementation.

Further, client device 110 is communicatively coupled to a display device (not shown in FIG. 1), for displaying graphical user interfaces, such as graphical user interfaces of web page 116. Such a display device may be implemented by any type of device capable of displaying a graphical user interface. Example implementations of a display device include a monitor, a screen, a touch screen, a projector, a light display, a display of a tablet computer, a display of a telephony device, a television, etc.

Network 130 may be implemented with any type of medium and/or mechanism that facilitates the exchange of information between client device 110 and server device 120. Furthermore, network 130 may facilitate use of any type of communications protocol, and may be secured or unsecured, depending upon the requirements of a particular embodiment.

Server device 120 may be implemented by any type of computing device that is capable of communicating with client device 110 over network 130. In network arrangement 100, server device 120 is configured with a grammar service 122, an error location service 124, an error correction service 126, and a remediation service 128. One or more of services 122-128 may be part of a cloud computing service. Functionality attributed to one or more of services 122-128 may be performed by grammar client 112, according to embodiments. Services 122-128 may be implemented by one or more logical modules, and are described in further detail below. Server device 120 may be configured with other mechanisms, processes and functionalities, depending upon a particular implementation.

Server device 120 is communicatively coupled to database 140. Database 140 may reside in any type of storage, including volatile and non-volatile storage (e.g., random access memory (RAM), one or more hard or floppy disks, main memory, etc.), and may be implemented by multiple logical databases. The storage on which database 140 resides may be external or internal to server device 120.

Any of grammar client 112 and services 122-128 may receive and respond to Application Programming Interface (API) calls, Simple Object Access Protocol (SOAP) messages, requests via HyperText Transfer Protocol (HTTP), HyperText Transfer Protocol Secure (HTTPS), Simple Mail Transfer Protocol (SMTP), or any other kind of communication, e.g., from one of the other services 122-128 or grammar client 112. Further, any of grammar client 112 and services 122-128 may send one or more of the following over network 130 to one of the other entities: information via HTTP, HTTPS, SMTP, etc.; XML data; SOAP messages; API calls; and other communications according to embodiments.

In an embodiment, each of the processes described in connection with one or more of grammar client 112 and services 122-128 are performed automatically and may be implemented using one or more computer programs, other software elements, and/or digital logic in any of a general-purpose computer or a special-purpose computer, while performing data retrieval, transformation, and storage operations that involve interacting with and transforming the physical state of memory of the computer.

### Sentence Problems Stored at the Database

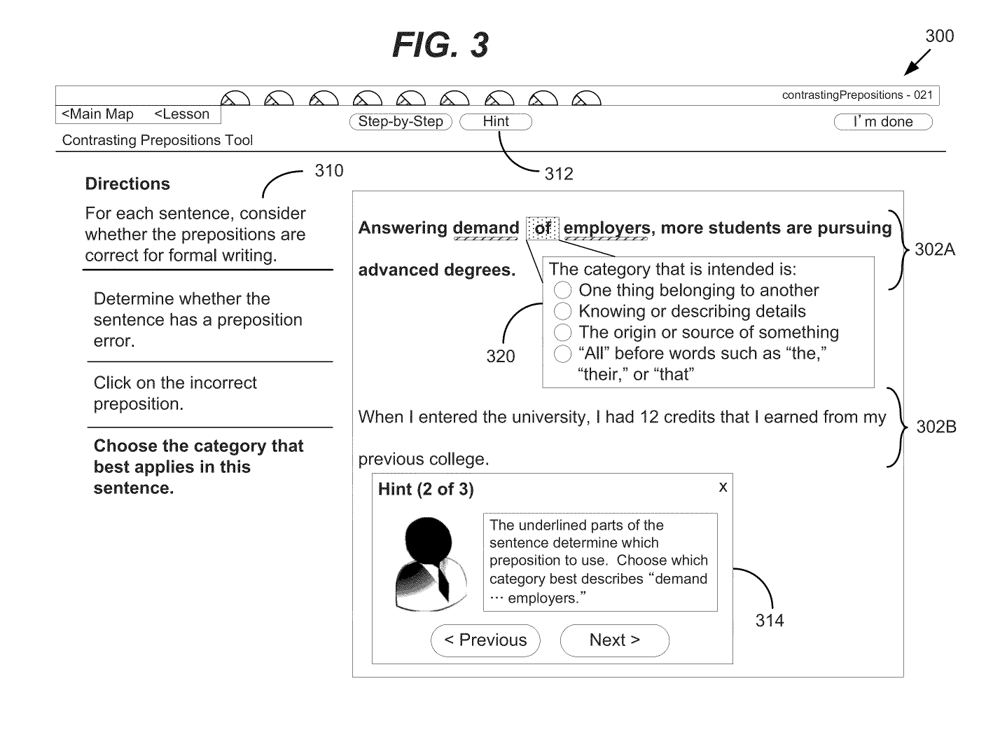

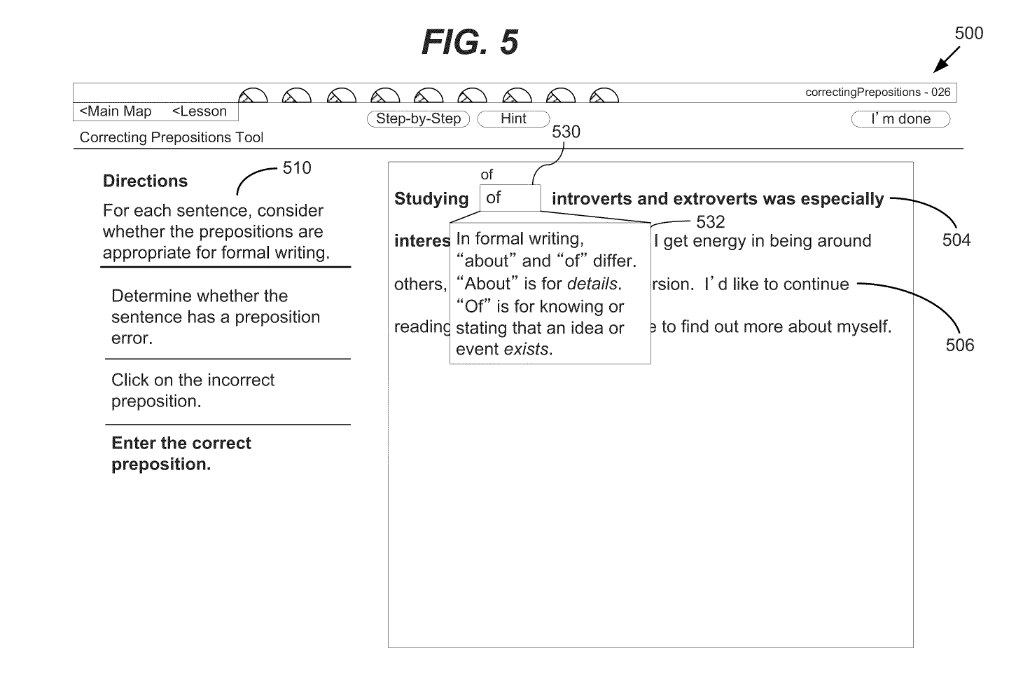

According to embodiments, a preposition problem includes either (a) a single sentence, (b) a pair of sentences (GUI 300 in FIG. 3), or (c) a paragraph (GUI 500 in FIG. 5). A set of problem data may also include one or more of:
a problem type indicating a preposition problem;
markup of a preposition problem sentence (as described in further detail below);
information that may be presented as hints;
for each location in the sentences for a preposition, a type of preposition including a preposition that is present but used incorrectly, a preposition that is missing but necessary, and a preposition that is correct as-is;
for each preposition that requires correction or adding, one or more acceptable correction options as well as any incorrect answers including prepositions that are inappropriate, incorrect answers that may be confused with prepositions including infinitive verbs such as “to eat”, and answers that are informal prepositions or casual speech;
remediation information for incorrect answers, as necessary;
for each preposition that requires correction, a preposition category for affecting grammar skills, as discussed above in Section 1.0, including: 1) distinguishing prepositions for knowledge narratives, for example using “inform of” versus “inform about” and similar verbs, 2) the preposition “from” being used for a source or origin, 3) the preposition “of” being used for belonging, 4) distinguishing the prepositions “between” versus “among”, 5) distinguishing the prepositions “in” versus “into”, 6) the preposition “all” with words such as “the” or “that”, 7) the preposition “couple” before a noun phrase, and 8) a sentence with no error;
for each preposition category, a reference to a portion of the sentence that causes the preposition to fall under that preposition category, if necessary.

In some embodiments, some of the above metadata may not be explicitly specified by the problem writer. For example, if a sentence only contains correction options that indicate placed prepositions that are correct as-is, then the sentence may automatically be categorized into sentence type 8, or a sentence with no error, without the problem writer having to explicitly specify as such in the metadata.

To illustrate, database 140 may include, in connection with a particular set of problem data, metadata embedded into the following marked-up sentence:
There are [_prepInfo]several specific fields[/_prepInfo]
[_infinitiveVerb] [_infinitiveTo]to [/_infinitiveVerb] choose[/infinitiveVerb]
[_incorrectPreposition]of[/_incorrectPreposition] when $selecting a career
[_preposition]within[/_preposition] hospitality, such as travel and tourism.

The embedded metadata variable (“$selecting”) facilitates creating alternate wordings for the marked-up sentence. For example, database 140 also includes the following definitions of the embedded variable:
‘selecting’:RandomChoiceGenerator(choices=[‘selecting’, ‘pursuing’, ‘considering’]).
   According to an embodiment, the variables are resolved before the sentence is stored at database 140. Thus, the problems may be written with metadata to allow multiple alternative wordings. For example, by adding additional metadata variables, different prepositions may be substituted as alternatives, prepositions may be placed or not placed according to random selection, different phrases may be selected at random, and elements may be rearranged into different orders within the sentence, allowing a wide range of possible problem sentences and sentence types to be generated from a small amount of metadata.

According to an embodiment, metadata for a sentence includes a tag that grammar service 122 may use for remediation information. Such metadata identifies one or more portions of a sentence that are correct. For example, a particular marked-up sentence includes the metadata tag [_preposition/], which indicates to grammar service 122 that a preposition is located where the tag is positioned, and that the preposition is correctly used. As described in further detail below, remediation service 128 may use such metadata to identify particular remediation information to display to a user. For example, if a user identifies the preposition in a particular displayed sentence as an extraneous preposition that should be removed, then remediation service 128 uses the tag that marks that preposition to identify remediation text to display to the user. For example, the remediation text may indicate that the preposition is being used correctly and should therefore remain.

### Preposition Problem Categories

According to an embodiment, preposition errors in database 140 are authored to present one of the following three categories: (a) a single sentence that may include zero or more preposition errors, (b) a pair of sentences that may each include zero or more preposition errors; and (c) a paragraph with one or more preposition errors. By presenting contrasting pairs of sentences in the (b) category, the application of preposition regularities may become easier to understand for the user. The sentence pairs may be written such that the subject matter or topic of each sentence is the same, with differences only in the grammatical structure that affects preposition choice, thereby directing the user's focus. The (a) and (b) categories may be divided into discrete sections based on specific preposition regularities or preposition categories, providing logical separation for gradual mastery of preposition regularities, one regularity at a time.

Once a certain level of mastery is reached, then the user may move to questions in the (c) category, which presents a paragraph that may contain preposition errors from multiple (a) sections. The paragraph may correspond to a subset of a longer paragraph, and the subset may be selected to respect sentence dependencies within the longer paragraph. For example, if the second sentence in the longer paragraph refers to the first sentence, such as by using a phrase similar to “as discussed above”, then the subset is selected such that the first and second sentences are either selected or omitted together.

In each category of problems, the user may be asked to complete one or more tasks, including 1) identifying whether there is a preposition error or not, and whether a preposition needs to be changed, added, or removed, 2) if there is a preposition error, identifying the specific preposition to be removed or changed or the specific location to add a preposition, 3) identifying the category that the preposition usage falls under, and 4) providing the corrected preposition, if necessary. Other problem structures for preposition errors may also be presented to users within embodiments. As the user progress through the above tasks, instructions 310 and 510 as shown in FIG. 3 and FIG. 5 may be updated to reflect the current task at hand.

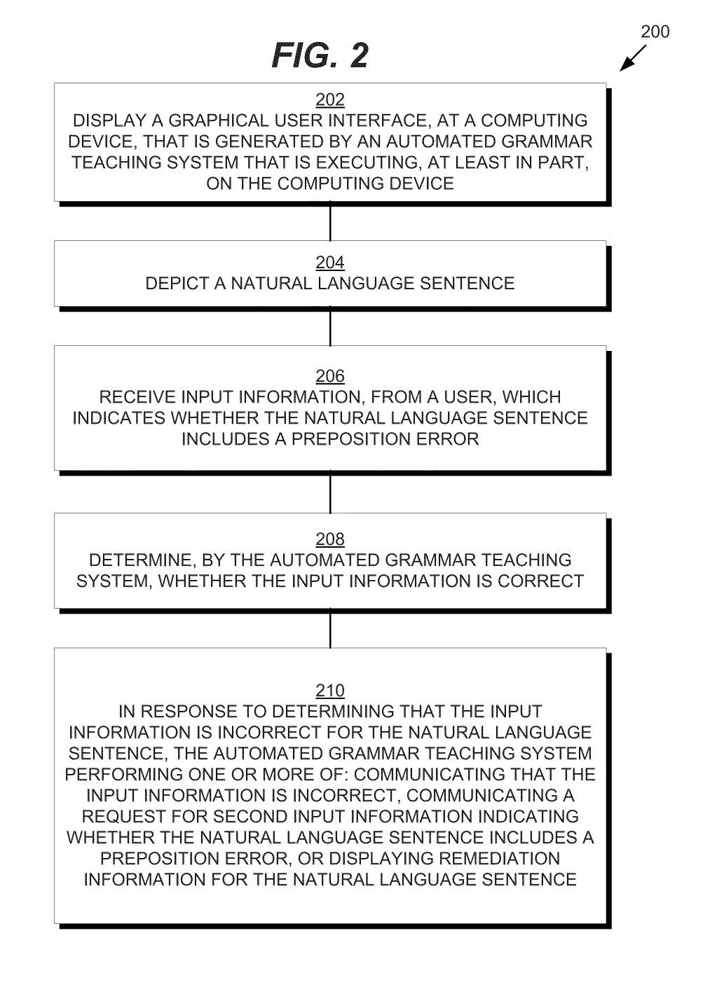

To identify the presence or absence of a preposition error in step 1) above, the user may for example click on a list of possible choices that is presented in the user interface. In step 2), the preposition to be removed or changed may be clicked, or the space between words to insert a new preposition may be clicked. Grammar service 122 may utilize error location service 124 to identify the specific locations in the sentences that require the removal or addition of a preposition, which may proceed similarly to the processes described in FIG. 2.2 and FIG. 2.3A-2.3B and related text in Section 2.0 of the parent provisional application. To assist the user in visualizing the impact of a potential modification, a preview of a corrected sentence may appear as the user moves a mouse pointer over a particular preposition to be removed. For adding or modification of a preposition, the preview functionality may be disabled since the correct preposition is not yet provided by the user.

### Graphical User Interface Displaying a Sentence

FIG. 2 depicts a flowchart 200 for receiving input information from a user identifying preposition errors in a displayed natural language sentence. At step 202 of flowchart 200, a graphical user interface is displayed at a computing device, which graphical user interface is generated by an automated grammar teaching system that is executing, at least in part, on the computing device. For example, in FIG. 1, web page 116 includes a graphical user interface such as GUI 300 of FIG. 3, which is generated by grammar service 122 executing on server device 120 or by grammar client 112 executing on client device 110.

Grammar service 122 sends information for GUI 300, via network 130, to grammar client 112. Grammar client 112 makes GUI 300 available to browser 114 executing on client device 110, and browser 114 displays GUI 300, i.e., in web page 116. According to another embodiment, grammar client 112 causes GUI 300 to be displayed outside of a browser, e.g., as part of a stand-alone application.

At step 204 of flowchart 200, a natural language sentence is depicted, which may include zero or more preposition errors. To illustrate, GUI 300 depicts natural language sentences 302A and 302B that, according to an embodiment, may or may not include preposition errors. Grammar client 112 instructs users to determine whether each sentence includes a preposition error, as shown by instructions 310.

According to an embodiment, a preposition error may be categorized as, but not necessarily limited to, one of the following three types: 1) an incorrectly used preposition that needs to be changed, 2) an incorrectly used preposition that needs to be removed, or 3) a missing but required preposition. For example, sentence 302A may have a preposition error with the incorrect preposition “of” that needs to be changed to “from”, since the clause “demand . . . employers” indicates that the preposition should indicate the origin or source of something. On the other hand, sentence 302B may have no preposition error, since the preposition “from” is already being correctly used.

### Identifying Preposition Errors

At step 206, input information is received, from a user, which indicates whether the natural language sentence includes a preposition error. For example, grammar client 112 receives information, input by the user via GUI 300 that indicates whether sentence 302A has no preposition error or has a preposition error according to the three types discussed above. A user may indicate this in various ways, such as by clicking on a list of radio buttons as depicted in GUI 300, by entering a particular key stroke, etc. After the user is finished indicating his selections, the user may submit the selections by clicking on the button labeled “I'm done” or by various other means.

FIG. 3 includes instructions 310 that instruct a user to determine whether the preposition usage is correct within sentences 302A-302B. This depiction of instructions is non-limiting, and the instructions may be presented in other manners, with other wording, or may be entirely absent, within embodiments.

Assuming the user has correctly identified the preposition error as an incorrect preposition that needs to be changed, the user may be required to further identify the location of the preposition error. If a sentence includes multiple preposition locations, then it is possible that (1) the user need only make a correction at one of the locations in order to correct the preposition error; or (2) the user needs to make corrections at two or more of the locations in order to correct the preposition errors. These corrections may be made, for example, by clicking on an existing preposition to remove the preposition, by clicking on an existing preposition to type in a new preposition, or by clicking at a specific location to insert a new preposition. Thus, embodiments may include sentences that have one or more preposition errors, which may be identified and corrected by the user.

Assuming that there is only one preposition error, the user may provide input information by clicking on the preposition “of” in sentence 302A. In some embodiments, selections may be made by highlighting rather than single clicking, for example by clicking and dragging the desired selection. Additionally, as shown in window 320, the user may be prompted to select the correct preposition category for “of”. In some embodiments, the step of selecting the preposition category may be omitted. Assuming that the user correctly selects the third radio button, or “The origin or source of something”, the user may be finally prompted to type the correct preposition in. If the selection of the preposition category is omitted, then the user may be prompted to type the correct preposition in immediately after identifying the preposition error.

At step 208, the automated grammar teaching system determines whether the input information received from the user is correct. Assuming that the user correctly typed in the correction answer as “from”, grammar client 112 sends the information indicating the selected location, the selected preposition category, and the correction answer to grammar service 122. Grammar service 122 employs error location service 124 and error correction service 126 to determine whether the user correctly identified the location, category, and correction answer for the preposition error. For example, error location service 124 and error correction service 126 may verify the user input as correct by referencing the metadata stored in database 140 for sentence 302A. Otherwise, if the user selects the wrong location or provides the wrong correction, then the user input may be determined as incorrect. Step 208 may be carried out after the user provides input information for each problem step or task, and the user may be prevented from proceeding further until the user answers each problem step or task successfully.

Returning to flowchart 200 of FIG. 2, at step 210, the automated grammar teaching system performs one or more of the following actions in response to determining that the indicated input information is incorrect for the sentence:
communicating that the indicated input information is incorrect;
communicating a request for second input information; or
displaying remediation information for the incorrectly indicated sentence.

For example, assume that the user has indicated that no errors are present in sentence 302A, and has clicked on the “I'm done” button. In this case, error correction service 126 receives input information indicating that the user has incorrectly identified that no preposition errors exist for sentence 302A. As discussed above, these indications can be determined by examining the metadata in database 140.

According to an embodiment, in response to the above determination of error correction service 126, grammar client 112 communicates that the indicated input information is incorrect. For example, grammar client 112 displays text that informs the user that the user has not provided the correct selection for sentence 302A. As another example, grammar client 112 displays a symbol or plays a sound to indicate the incorrect selection for sentence 302A. As yet another example, grammar client 112 simply does not move on to another problem or another portion of the present problem, which communicates to the user that the user has not correctly selected the correct selection for sentence 302A.

According to another embodiment, in response to the above determination of error correction service 126, grammar client 112 communicates a request for second input information. For example, grammar client 112 displays text that requests that the user make another answer attempt. As another example, grammar client 112 highlights instructions 310 within GUI 300 (e.g., with bolded text, font color, highlight color, a displayed symbol, a displayed border, etc.).

### Hint Information

According to an embodiment, grammar client 112 displays hint information in connection with communicating that the indicated response is incorrect. For example, as illustrated in hint window 314, the clauses of sentence 302A that determine the preposition category are underlined and identified for the user. According to another embodiment, grammar client 112 displays hint information in response to detecting selection of hint button 312 (in GUI 300 of FIG. 3). Displayed hint information may be from one of various levels of hint information from the data for sentence 302A. Such levels may include (1) general instruction, (2) what concepts to think about for sentence 302A, and (3) what the correct answer is and why. Thus, as the user requests additional hints, the hints may progress from generalized rule statements to more specific instructions as applied to the specific problem at hand. The user may move forwards and backwards through the hints as desired.

Hints may also be presented in a contextually aware fashion. For example, hints may be tailored according to the specific portion or step of the problem that the user is working with. Additionally, in some embodiments, the hints may be provided proactively as a just-in-time intervention. If the user provides an incorrect response, then a just-in-time tooltip may be shown to provide guidance to the user. Additionally, as discussed above, a preview function may be provided to allow the user to see the potential impact of a preposition removal or change. In some embodiments, if the user lingers on a preview for a modification that is incorrect, for example, then a just-in-time tooltip may be shown, attempting to steer the user away from making the incorrect modification. For example, an explanation may be given why the preposition should remain in the sentence.

### Informal Hints

In some embodiments, less formalized hints may be given to assist the user. For example, some terms may be difficult to understand if the user is unfamiliar with formal grammar terminology. Thus, a less formalized explanation may be provided in the hints. As the user is exposed to formal grammar terminology, the hints may gradually transition to using formal terminology. Additionally, in some embodiments, an explanatory tooltip may be shown to the user when the user clicks on a glossary term. In some embodiments, the tooltip may be shown when the user hovers over a particular term. For example, if the user places a cursor over the word “preposition”, a tooltip may appear with a definition of “preposition” and some examples.

### Correcting a Preposition Error

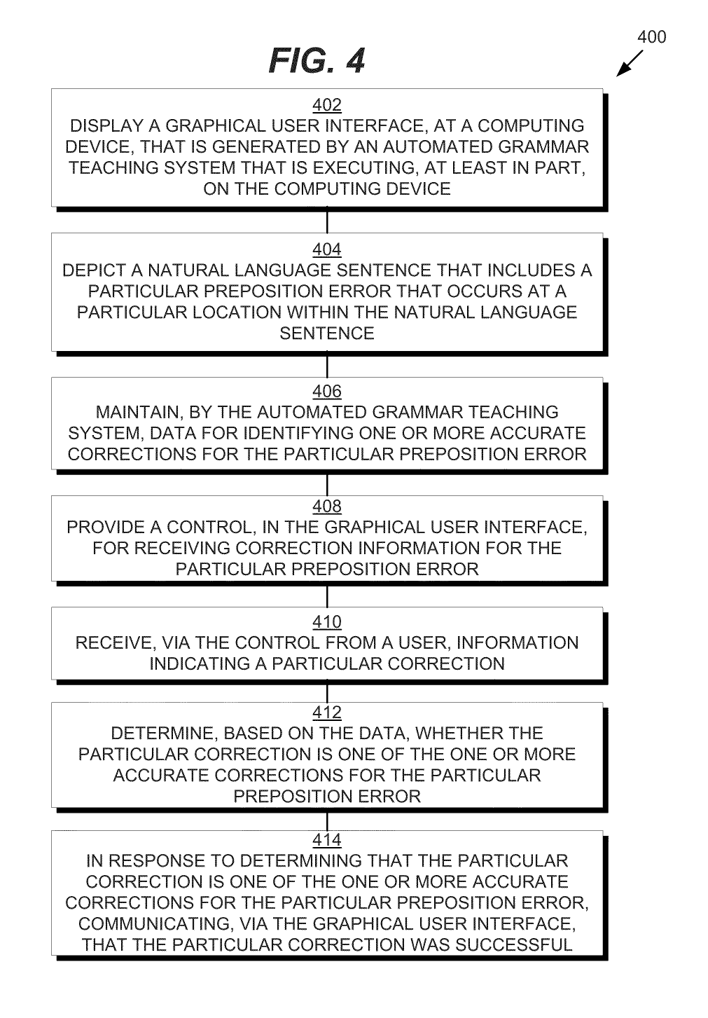

FIG. 4 depicts a flowchart 400 for receiving input information from a user identifying a correction of a preposition error in a displayed natural language sentence and determining whether the correction is accurate. At step 402 of flowchart 400, a graphical user interface is displayed at a computing device, which graphical user interface is generated by an automated grammar teaching system that is executing, at least in part, on the computing device. For example, web page 116 includes a GUI such as GUI 500 of FIG. 5, which is generated by grammar service 122 executing on server device 120 or by grammar client 112 executing on client device 110.

At step 404 of flowchart 400, a natural language sentence is depicted, which includes a preposition error that occurs at a particular location within the natural language sentence. For example, GUI 500 depicts natural language sentence 504 that includes a preposition error at the location contained within text box 530.

At step 406, the automated grammar teaching system maintains data for identifying one or more accurate corrections for the particular preposition error. For example, database 140 includes a set of one or more accurate correction options for the particular preposition error. To illustrate in the context of sentence 504, database 140 has information indicating that the following correction options are accurate for the preposition error in sentence 302:
The placed preposition “of” at the location contained within text box 530 is an incorrect preposition that should be corrected by replacing with “about”.
   While only one possible correction option is listed above, some problems may include multiple valid correction options in the metadata of database 140.

At step 408, a control is provided, in the graphical user interface, for receiving correction information for the particular preposition error. For example, grammar client 112 allows the user to type in a new preposition within text box 530 after identifying that sentence 504 contains a preposition at the location enclosed by text box 530, wherein the preposition needs to be changed to a new preposition.

At step 410, information indicating a particular correction is received via the control from a user. In the example shown in FIG. 5, remediation information 532 may appear if the user appears to be typing an incorrect answer, or if the user requests a hint. Based on this guidance, the user may correctly enter the correction of “about” within text box 530. Grammar client 112 receives information indicating that the user has submitted a correction of “about” and sends the information to grammar service 122.

At step 412, it is determined, based on the data, whether the particular correction is one of the one or more accurate corrections for the particular preposition error. For example, grammar service 122 employs error correction service 126 to determine whether “about” corresponds to a valid correction for the preposition. Error correction service 126 thus examines the set of correction options, stored at database 140, that are accurate for the preposition error in sentence 504.

Error correction service 126 compares “about” to each of the accurate correction options stored at database 140 in turn. In most cases, there will only be one accurate correction option, but in some cases multiple correct answers may be available. Since the metadata in database 140 may indicate that a valid correction is “about”, error correction service 126 determines that the particular correction is one of the accurate corrections. To provide some flexibility and to keep the focus on the substantive grammar rules, fuzzy searches or regular expressions may be supported to detect and ignore minor deviations such as spelling errors, incorrect capitalization, and excess whitespace. These deviations may be accepted as correct answers, with the corrected version shown to the user.

At step 414, in response to determining that the particular correction is one of the one or more accurate corrections for the particular preposition error, it is communicated, via the graphical user interface, that the particular correction was successful. In response, grammar client 112 may display text that informs the user that the user has accurately corrected the preposition error in sentence 504. As another example, grammar client 112 displays a symbol, such as a green checkmark, or plays a sound to indicate to the user that the user has accurately corrected the preposition error within sentence 504. As yet another example, grammar client 112 simply moves on to another problem or another portion of the present problem, such as sentence 506, which communicates to the user that the user has accurately corrected the preposition error within sentence 504. Additionally, instructions 510 may be updated to reflect the successful correction and provide directions for sentence 506.

### Post Problem Rule Explanations

To help the user become familiar with formal grammar terminology and regularities, explanations using formal grammar terminology may be provided after each successfully solved problem, even when informal hints are being provided. Explanations may be provided in the form of an on-screen character or avatar that coaches the user in a conversational style. After the user correctly answers a problem, the correct sentences may be displayed with the on-screen character commenting on the application of the rule.

### Remediation Information in Response to an Incorrect Selection

According to yet another embodiment, in response to the above determination of error correction service 126, grammar client 112 displays “remediation information” for the incorrectly indicated sentence. For example, remediation service 128 may use the metadata stored in database 140 to identify whether the insertion, modification, or deletion of a particular preposition by the user is incorrect and to determine whether associated remediation information is available. In an embodiment, grammar client 112 presents a user with targeted remediation information about mistakes made by the user in identifying preposition errors. Information on why the identified sentence is incorrectly indicated educates the user on proper preposition usage, and therefore reinforces the user's knowledge of how to properly form sentences using prepositions.

Remediation information includes information that explains to a user why a particular sentence is incorrectly identified as having or not having a preposition error. According to an embodiment, database 140 stores remediation information, including text to be displayed, for each stored sentence. According to another embodiment, database 140 stores a collection of remediation information display text indexed by unique identifiers. In this embodiment, remediation information for a particular sentence includes unique identifiers of remediation information stored in the collection.

Remediation information is created based on one or more of (a) academic literature about what students know and the mistakes that students make, (b) what subject matter experts and/or cognitive scientists know about how students learn, and (c) analysis of historical data gathered by grammar service 122. For example, grammar service 122 records, in historical data for a user, the mistakes that the user makes in identifying and correcting preposition errors, and what, if any, remediation information grammar client 112 was presented to the user in response to detecting the mistake. Trends in the historical data may be identified, e.g., by cognitive scientists, to determine what remediation information should be added to database 140.

Grammar client 112 displays remediation information when the user incorrectly identifies the presence or absence of a preposition error for any of the sentences. As discussed above, this may be determined by examining metadata within database 140 for a sentence in question. Remediation information may be shown in a pop-up window, similar to remediation information 406 in GUI component 412 of FIG. 2.4, as discussed in Section 2.0 of the parent provisional application. For example, if the user types the wrong preposition in text box 530, then remediation information 532 may appear. This information may appear as the user is typing, or only after the user submits the answer by clicking the “I'm done” button. The user may then proceed to retry the problem with a different preposition. If the user is still confused, the user may request additional hints by clicking on the hint button, as described above.

According to this embodiment, database 140 contains remediation information for one or more of the following:
Identifying a correctly used preposition as an erroneous preposition;
Identifying a word that is not a preposition as an erroneous preposition;
Identifying the to in an infinitive verb (e.g., to eat) as a preposition;
Identifying a preposition as incorrect simply because it comes at the end of a sentence (sometimes viewed in popular belief as an error, but not a rule advocated by grammarians);
Inserting a preposition where a preposition is already present;
Inserting a preposition where a preposition is not needed;
Correcting the sentence with a word that is not a preposition;
Correcting the sentence with a word that is a preposition but that is not appropriate for the particular sentence at hand;
Correcting the sentence with the wrong member of one of several pairs of prepositions that are frequently confused (e.g., between versus among, or into versus in)
Correcting the sentence in a way that might be appropriate in casual speech or informal writing but that is not appropriate for formal writing (e.g., writing couple a rather than couple of).

### Sequence of the Sentence Problem

According to an embodiment, grammar client 112 presents a control for receiving correction information for a sentence only in response to the user correctly identifying the location of a preposition error within the sentence. According to another embodiment, a control for receiving correction information for a sentence is presented in response to either: the user identifying the correct location of the preposition error within the sentence; or grammar client 112 displaying information showing, to the user, the correct location of the error.

For example, grammar client 112 displays information showing, to the user, the correct location of a preposition error once the user has selected a threshold number of locations, within a displayed sentence, that do not substantially match the correct location of a preposition error within the sentence. The user may be given a control to dismiss the information showing the correct location of the error; in such an embodiment, the control for receiving correction information is displayed in response to grammar client 112 detecting activation of the control to dismiss the information showing the correct location of the error.

According to another embodiment, grammar client 112 displays a control for receiving correction information for a sentence without requiring that the user correctly identify the location of a preposition error within the sentence.

### Tracking and Using Historical Data

Grammar service 122 identifies which problem to display to a user based, at least in part, on user information stored at database 140. According to an embodiment, the automated grammar teaching system of FIG. 2.1 in the parent provisional application is configured to maintain historical data for a user, e.g., in a user profile for the user stored at database 140. Such historical data includes one or more of: previous problems that have been presented to the user, types of previous problems that have been presented to the user, correct and incorrect answers given by the user, timing of viewing and answering presented questions, etc.

Based, at least in part, on the historical data, grammar service 122 identifies problems, to present to the user, that target concepts within preposition selection with which the user has had trouble. The way that grammar service 122 interprets the data is configurable by an administrator of the system. For example, an administrator sets a rule in grammar service 122 that states that a user needs additional practice for a particular sentence type when the user misses over 50% of problems that feature the particular sentence type during the past seven days. At a certain point in time, the historical data for a particular user indicates that the user has made mistakes on a particular type of sentence 80% of the times that sentences of this type have been presented to the user in the past week. Based on this historical data and the administrator-set rule, grammar service 122 presents sentences of that type to the user at a higher rate than other types of sentences until grammar service 122 identifies that the rate of making mistakes on this type of problem is no longer over 50%.

According to embodiments:
A set of selection skills that users are expected to master are identified, e.g., by cognitive scientists and/or subject matter experts;
Steps in individual problems are associated with particular selection skills, e.g., by cognitive scientists and/or subject matter experts;
As the user progresses, the user's probability of mastery for each individual selection skill is automatically calculated (according to Bayesian Knowledge Tracing), e.g., by grammar service 122; and
Problems that have associated selection skills that the user has not mastered are automatically presented, until the user has mastered all of the selection skills associated with available preposition problems, e.g., by grammar service 122.

In connection with sentences with preposition errors, grammar service 122 may track selection skills that are affected in various ways by the 8 sentence types listed above in the metadata stored in database 140.

### Corrections Of Multiple-Sentence Paragraphs

According to an embodiment, at least some of the problems in database 140 include data for multiple sentences that are configured to be presented all together to a user, i.e., in paragraph form. For example, FIG. 5 depicts a GUI 500 in which a paragraph 502 is displayed, having sentences 504 and 506. In the embodiment of GUI 500 of FIG. 5, grammar client 112 causes each sentence to be highlighted in turn, and allows a user to determine whether the highlighted sentence includes a preposition error. The user may be asked to complete various tasks for a particular sentence, such as sentence 504, prior to moving on to another displayed sentence (e.g., sentence 506). For example, as discussed above, the user may be asked to 1) identify whether a preposition error exists, 2) locate the preposition error, and 3) provide the correct preposition, if necessary.

For example, after sentence 504 is highlighted, the user may be given a choice to select 1) a new preposition should be inserted into sentence 504, 2) an existing preposition should be changed in sentence 504, 3) an existing preposition should be deleted from sentence 504, or 4) sentence 504 is correct as-is. If the user correctly determines that there is not a preposition error and chooses selection 4), then grammar client 112 highlights a different sentence of the plurality of displayed sentences and continues as with the first highlighted sentence. However, if a preposition error does exist, then the user must select either selection 1), 2) or 3) depending on the appropriate correction. Assuming the user correctly chooses selection 2), instructions 510 direct the user to identify the location of the preposition to change, or more specifically to choose the incorrect preposition. As discussed above, this may be done by clicking on the preposition “of” to bring up a text box 530 for typing in a correction.

As shown in FIG. 5, the user has selected “of” for changing. After the user provides the correct preposition, or “about”, then the user may move to sentence 506 once this query is successfully answered. However, if the user is unsure of the correct preposition, the user may request a hint by clicking on the hint button, as previously discussed.

Providing the user multiple sentences in the form of a paragraph gives the user a more realistic simulation of applying preposition rules in the real-world setting of drafting and editing a paragraph. Users must be able to apply preposition rules in the context of a multiple-sentence paragraph, as displayed in GUI 500. Further, the paragraphs may contain multiple sentence types, multiple preposition errors, and complex sentences with multiple potential locations for preposition errors. Thus, completing paragraph-style problems as in GUI 500 can help better prepare such users to correctly apply preposition rules in prose-style writing assignments and other writing opportunities.

### Intelligent Tutoring System for Automatically Teaching Grammar

According to an embodiment, grammar service 122 and/or grammar client 112 is implemented as part of an intelligent tutoring system, such as the cognitive tutor described in Kenneth R. Koedinger, John R. Anderson, William H. Hadley, & Mary A. Mark Intelligent tutoring goes to school in the big city §2.2 (7th World Conference on Artificial Intelligence in Education 1995), which paper is incorporated herein by reference.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

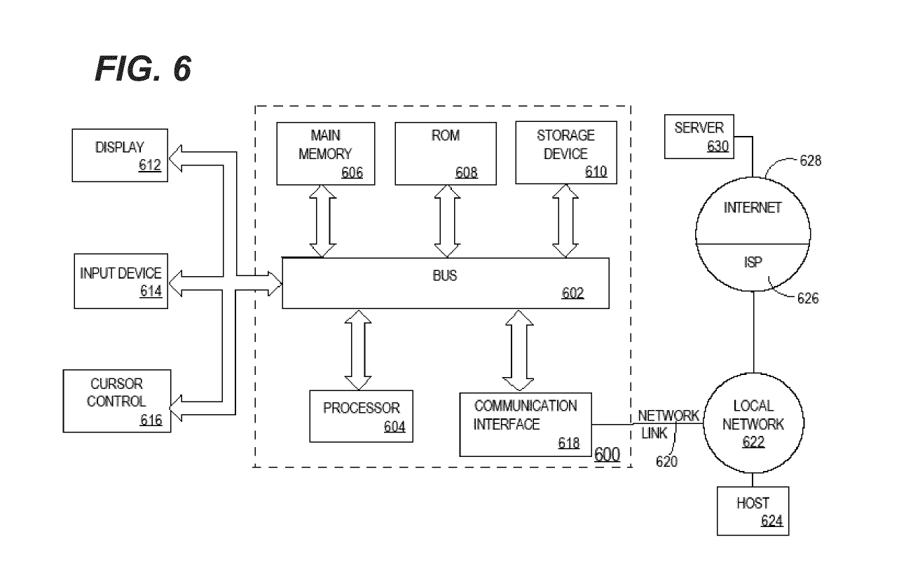

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and preposition selections to processor 604. Another type of user input device is cursor control 616, such as a mouse, a trackball, or cursor direction keys for communicating direction information and preposition selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-executed method comprising:
displaying a graphical user interface that is generated by an automated grammar teaching system that is executing, at least in part, on a computing device;
depicting a natural language sentence on the graphical user interface;
receiving input information, from a user, which indicates whether the natural language sentence includes a preposition error;
determining, by the automated grammar teaching system, whether the input information is correct;
in response to determining that the input information is incorrect for the natural language sentence, the automated grammar teaching system performing one or more of:
communicating that the input information is incorrect,
communicating a request for second input information indicating whether the natural language sentence includes a preposition error, or
displaying remediation information for the natural language sentence.

2. The method of claim 1, further comprising, prior to the receiving, communicating one or more hints for the natural language sentence.

3. The method of claim 1, wherein the communicating that the input information is incorrect further communicates one or more hints for the natural language sentence.

4. The method of claim 1, wherein the remediation information comprises identifying one or more grammar elements of the natural language sentence.

5. The method of claim 4, wherein the one or more grammar elements are usable to determine the preposition error.

6. The method of claim 4, wherein the identifying includes underlining one or more grammar elements in the graphical user interface.

7. The method of claim 1, further comprising:
in response to determining that the second input information is correct for the natural language sentence, the automated grammar teaching system performing one or more of:
providing a preposition rule explanation as applied for the natural language sentence,
communicating a request for third input information indicating a location of the preposition error; or
communicating a request for third input information indicating a grammar rule being applied for the natural language sentence.

8. The method of claim 1, further comprising:
recording, in a set of historical data for the user, information about the depicted natural language sentence and the indicated input information;
based, at least in part, on the set of historical data for the user, selecting a second natural language sentence; and
displaying a second graphical user interface, at the computing device, that depicts the second natural language sentence.

9. A computer-executed method comprising:
displaying a graphical user interface, at a computing device, that is generated by an automated grammar teaching system that is executing, at least in part, on the computing device;
depicting a natural language sentence that includes a particular preposition error that occurs at a particular location within the natural language sentence;
maintaining, by the automated grammar teaching system, data for identifying one or more accurate corrections for the particular preposition error;
providing a control, in the graphical user interface, for receiving correction information for the particular preposition error;
receiving, via the control from a user, information indicating a particular correction;
determining, based on the data, whether the particular correction is one of the one or more accurate corrections for the particular preposition error;
in response to determining that the particular correction is the one or more accurate corrections for the particular preposition error, communicating, via the graphical user interface, that the particular correction was successful.

10. The method of claim 9, wherein the data for identifying the one or more accurate corrections include, for each location for a preposition in the natural language sentence, whether:
an incorrectly used preposition needs to be changed, or
a missing preposition needs to be added.

11. The method of claim 9, wherein the information indicating the particular correction includes a new preposition to place at the particular location.

12. The method of claim 11, wherein the information indicating the particular correction includes a selection of a correct preposition usage category for the new preposition.

13. The method of claim 9, further comprising, prior to the receiving:
displaying a preview of a candidate correction applied to the natural language sentence, the candidate correction based on a position of a pointer in the graphical user interface.

14. The method of claim 13, further comprising, prior to the receiving:
showing a just-in-time tooltip for the candidate correction not being the one or more accurate corrections for the particular preposition error.

15. The method of claim 9, wherein the depicting of the natural language sentence comprises the graphical user interface highlighting the natural language sentence within a paragraph, the highlighting by one or more of bolded text, font color, highlight color, a displayed symbol, or a displayed border.

16. The method of claim 15, wherein the communicating comprises the graphical user interface highlighting a different natural language sentence within the paragraph.

17. The method of claim 9, wherein the remediation information is based on one or more of:
academic literature about what students know about prepositions and the mistakes students make about prepositions;
cognitive learning models from subject matter experts and/or cognitive scientists; or
a recorded set of historical data for the user.

18. A non-transitory computer-readable medium storing one or more sequences of instructions which, when executed by one or more processors, cause performing of:
displaying a graphical user interface, at a computing device, that is generated by an automated grammar teaching system that is executing, at least in part, on the computing device;
depicting a natural language sentence that includes a particular preposition error that occurs at a particular location within the natural language sentence;
maintaining, by the automated grammar teaching system, data for identifying one or more accurate corrections for the particular preposition error;
providing a control, in the graphical user interface, for receiving correction information for the particular preposition error;
receiving, via the control from a user, information indicating a particular correction;
determining, based on the data, whether the particular correction is one of the one or more accurate corrections for the particular preposition error;
in response to determining that the particular correction is the one or more accurate corrections for the particular preposition error, communicating, via the graphical user interface, that the particular correction was successful.

19. The non-transitory computer-readable medium of claim 18, wherein the information indicating the particular correction includes a new preposition to place at the particular location.

20. The non-transitory computer-readable medium of claim 18, wherein the remediation information is based on one or more of:
academic literature about what students know about prepositions and the mistakes students make about prepositions;
cognitive learning models from subject matter experts and/or cognitive scientists; or
a recorded set of historical data for the user.
